(19) United States
(12) Patent Application Publication
(10) Pub. No.: US 2025/0100454 A1
(43) Pub. Date: Mar. 27, 2025

(54) LUGGAGE COMPARTMENTS FOR VEHICLES

(71) Applicant: Gordon Murray Automotive Limited, Shalfrod (GB)

(72) Inventor: Ian Gordon Murray, Puttenham (GB)

(21) Appl. No.: 18/833,323

(22) PCT Filed: Jan. 24, 2023
(86) PCT No.: PCT/EP2023/051698

§ 371 Date: Jul. 25, 2024

(30) Foreign Application Priority Data
Jan. 25, 2022 (GB) 2200948.4

(51) Int. Cl. B60R 5/00; B60J 5/04; B62D 25/02; B62D 25/08

(52) U.S. Cl. CPC B60R 5/00; B60J 5/0491; B62D 25/02; B62D 25/087

(57) ABSTRACT

A motor vehicle having an outer bodywork surface including front and rear wheel arches and at least one passenger or driver door on each side of the vehicle, in which a luggage compartment is provided on at least one side of the vehicle, each luggage compartment being located within the outer surface and forwardly of the rear wheel arch, the luggage compartment having an opening which extends at least partially over the top of the luggage compartment and which is closable with a hinged panel, the panel forming part of the outer bodywork surface of the vehicle and having a hinge which is located behind the rear of the luggage compartment and towards the rear of the vehicle.

### CROSS-REFERENCE TO RELATED APPLICATION

This Application is a Section 371 National Stage Application of International Application No. PCT/EP2023/051698, filed 24 Jan. 2023, and published as WO 2023/144151 on 3 Aug. 2023, in English, which claims priority to GB patent application number 2200948.4, filed on 25 Jan. 2022, the contents of which are hereby incorporated by reference in their entirety.

### FIELD OF THE INVENTION

The present invention relates to luggage compartments for motor vehicles, in particular for passenger cars, and particularly but not exclusively to rear-engined motor vehicles.

### BACKGROUND ART

There are many different designs of passenger car, and one aspect of car design is the provision of luggage space. In most cars there is a luggage compartment towards the rear, in other cars there may be a luggage compartment at the front, in addition to or instead of the rear luggage compartment; both compartments are usually accessible from outside the vehicle. The provision of luggage space becomes problematic when there is little room in the overall vehicle envelope, or body, perhaps because the vehicle is small, low in height and/or the interior of the vehicle envelope is mainly given over to the passenger compartment with the remaining space being required for the engine, transmission, wheels, suspension, fuel tank and all the other physical elements which enable the vehicle to be driven safely. In such tightly-packaged designs it can be difficult to accommodate much luggage space without compromising the vehicle's aesthetic appearance, its weight distribution and/or the driving characteristics of the vehicle. Many conventional vehicle luggage compartments have an opening on the exterior of the vehicle; these openings require doors to seal them against the elements, locking mechanisms to hold the door closed, and hinge mechanisms which are usually arranged to hinge about a horizontal axis, and so also have lift means to assist in opening. All of these features of conventional luggage compartment doors add undesirable weight to the vehicle, which affects fuel consumption adversely.

Conventional attempts to provide adequate luggage space has led to the provision of roof racks, boot racks and the like for carrying luggage, and to the development of lockable exterior containers which are intended to be carried on the roof or other part of the vehicle; however, all of these approaches have adverse effect to the vehicle's aesthetics, its aerodynamic performance (leading to increased fuel consumption, which is extremely undesirable in today's environmentally-conscious world, and also lower top speed and acceleration, which are undesirable in the performance car market) and to its driving/handling characteristics. There remains a need for a design of motor vehicle to provide luggage compartments which utilise space within the vehicle envelope, and which allows adequate access to the compartments but without significantly increasing the vehicle's overall weight or compromising other elements of the vehicle's design.

In what follows it is assumed that the reader is conversant with the following general aspects of motor vehicle design: a motor vehicle has a front end, which is the end of the vehicle which leads (or is “leading”) when the vehicle is being driven normally, and a rear end, which is the end which leads when the vehicle is being driven in reverse (while the front end trails, or is “trailing”). The terms forward, rear, leading, trailing and the like used herein should be interpreted according to these well-known vehicle design features, and the longitudinal direction should be considered the direction in which the vehicle moves when driven with no steering applied. Motor vehicles have left and right sides which are separated in the transverse direction, and they have wheels which fit within front and rear wheel arches on either side of the vehicle; most or all of the passenger compartment is normally located between the wheel arches, and on each side of the vehicle there is usually at least one door for use by a driver and/or passenger to access the passenger compartment. The term “rearmost” is used in relation to passenger doors to admit the possibility of there being one, two or more passenger doors on a side of the vehicle, and is intended to denote the passenger door which is located closest to the rear of the vehicle; where used in relation to other elements, the term should be construed similarly. Motor vehicles generally have an engine mounted at the front, midway or at the rear of the vehicle, and main luggage compartments are often provided at the front and/or rear of the vehicle. The terms vertical, longitudinal and transverse are to be construed relative to the vehicle.

### SUMMARY OF THE INVENTION

The present invention is predicated on the twin realisations that many vehicle designs have a chassis or a monocoque design in which some of the exterior body panels are only external bodywork and have little structural function (being present mainly for aesthetic and aerodynamic purposes) but which may be given a useful function, and that in many vehicle designs there are volumes which are largely unused, empty space and which can be usefully employed as luggage compartments.

The present invention therefore provides a motor vehicle having an outer bodywork surface including front and rear wheel arches and at least one passenger or driver door on each side of the vehicle, in which a luggage compartment is provided on at least one side of the vehicle, each luggage compartment being located within the outer bodywork surface and forwardly of the rear wheel arch, the luggage compartment having an opening extending at least partially over the top of the luggage compartment and which is closable with a hinged panel, the panel comprising a bodywork panel forming part of the outer surface of the vehicle and having a hinge which is located behind the rear of the luggage compartment and behind the rear wheel arch towards the rear of the vehicle. With such an arrangement the luggage compartment is sited inboard of the vehicle's side and preferably immediately ahead of the vehicle rear wheel arch, so that the rear wall of the luggage compartment can form the front part of the rear wheel arch. The compartment is located in the vicinity of the trailing edge of the vehicle rearmost side door, in an area through which a passenger or driver passes on entering or leaving the vehicle passenger compartment; thus from the side the compartment is located in the area delineated by the front portion and the top of the seat within the vehicle, the rear wheel arch, and the outside and the bottom of the vehicle, so does not compromise the accessibility of the vehicle passenger compartment. Whilst in many vehicles this region is provided with structural members to provide strength and rigidity, the walls forming the luggage compartment can be made sufficiently strong and be appropriately shaped and configured so as not to detract from the structural strength and integrity at this region. In rear-or mid-engined car designs the longitudinal distance between the rear wheels and the rear edge of the rearmost passenger doors is often greater than the longitudinal distance between the front wheels and the front edge of the frontmost passenger doors because of the space needed to accommodate the engine, so this location of the luggage compartment(s) is particularly suitable for use in such vehicle designs.

The luggage compartment is closed by way of a panel which forms part of the outer surface of the vehicle and which seals against the opening to the luggage compartment. This arrangement utilises the existing bodywork panel to provide the opening to the compartment; conventionally, this panel is provided for mainly aesthetic and aerodynamic purposes, and to use it also to access the luggage compartment adds little by way of structural requirement, and so adds little additional weight to the motor vehicle.

The panel has a hinge which is located behind the rear of the luggage compartment and towards the rear of the vehicle. This means that this rear side body panel acts as a form of “suicide door” to the luggage compartment, and provides the maximum accessibility to the opening for loading or unloading luggage. Where the vehicle is mid-or rear-engined, the panels give additional access to the engine bay, and if the hinge is made releasable the panel may be removed completely to give clearer access to the engine bay. The person using the luggage compartment (and the luggage therein) is shielded from the weather from the rear by the opened panel and from the front by the open rearmost passenger door. Preferably the hinge is located as close to the rear of the vehicle as possible; this means that the length of the panel is approximately equal to the rear three-quarter length of the vehicle (because it must extend from the rear of the vehicle, over the rear wheel arch towards the passenger door) and this allows the panel to open at its leading edge to give adequate access to the luggage compartment, and to close, without the panel having to pivot through too large an angle.

The hinge may have an axis about which the hinge pivots when the panel is opened or closed, in which the axis is oriented so as to have both a vertical and a transverse component. There should be at least a minor component in the transverse direction so that on opening the panel it swings not only outwardly but also upwardly; this is advantageous in that it allows the seal between the panel and the opening, or aperture, of the luggage compartment to be made and unmade (on closing/opening the panel) through contact and pressure and without any sliding component, which could abrade the seal over time. The minor component in the transverse direction also avoids the rearmost edge of the panel from clashing with the rear bumper of the vehicle, and it provides a “self-closing” effect in that the weight of the panel assists in the closing movement, so little effort is required to shut the panel. Additionally or alternatively the axis may be oriented so as to have a component perpendicular to the vertical and transverse directions. This may be required, depending on the precise geometry of the opening to the luggage compartment and the panel where it comes into contact with the opening, so as to allow the seal between the opening of the luggage compartment and the panel to be opened and closed without any sliding motion. The vertical component is preferably predominant over those in the other orthogonal directions so that opening and closing the panel does not move the panel through a substantial vertical distance, meaning that less effort is required to open and close the panel, and the hinge can be of a simple, lightweight, yet robust design.

The panel preferably has a leading edge at its forward end, the panel extending so that in the closed position at least part of the leading edge is positioned forwardly of the rearmost part of the rearmost door on that side of the vehicle. In this way, the overlap of the closed rearmost door positively retains the panel in the closed position and is an important safety feature as it prevents the panel from opening when the vehicle is being driven. The panel at its leading edge may be shaped and configured so as to be complementary to the shape and configuration of the rearmost part of the rearmost door on that side of the vehicle, this aids in sealing the panel against the opening and assists in maintaining the desired aerodynamic shape of the bodywork at the point where the door overlaps the panel.

The opening to the luggage compartment extends at least partially over the top of the luggage compartment, and/or it may extend at least partially down the outer side of the luggage compartment (but preferably not as far as the floor of the vehicle). This allows the interior of the luggage compartment to be accessed from above and/or from the side, and for it to extend vertically downwardly, which is convenient for the retention of luggage therein while the vehicle is driven-the vertical walls of the luggage compartment extend upwardly to form a lip which defines the aperture, or opening to the compartment, and around which a rubber seal may be applied to form the seal when the panel is closed. The lip is formed at the top edge of the compartment walls, and dips down towards the vehicle floor on the outer side of the compartment.

Although the panel is not pivoted vertically to any great extent, there may be a telescopic strut such as a gas or hydraulic strut or mechanical spring or the like having one end fixed to the vehicle and its other end fixed to the panel, for assisting in opening the panel and/or for holding the panel in its open position. The panel itself need not be significantly heavier than if it were fixed in place, and the hinge and locking arrangements need not be as robust and therefore heavy as with conventional, horizontally hinged luggage compartment lids. The motor vehicle may comprise two luggage compartments and two closable panels, one of each on each side of the vehicle; this provides a balanced load-carrying arrangement, which assists in providing good vehicle handling.

### BRIEF DESCRIPTION OF THE DRAWINGS

The invention will now be described by way of example and with reference to the accompanying figures, in which:

FIG. 1 is a schematic plan view of a vehicle in accordance with the invention;

FIG. 2 is a schematic rear perspective view of the vehicle of FIG. 1;

FIG. 3 is a schematic front and side view of part of the vehicle shown in FIGS. 1 and 2, and

FIG. 4 is a schematic perspective view of a panel forming part of the vehicle shown in FIGS. 1 to 3.

### DETAILED DESCRIPTION OF THE EMBODIMENTS

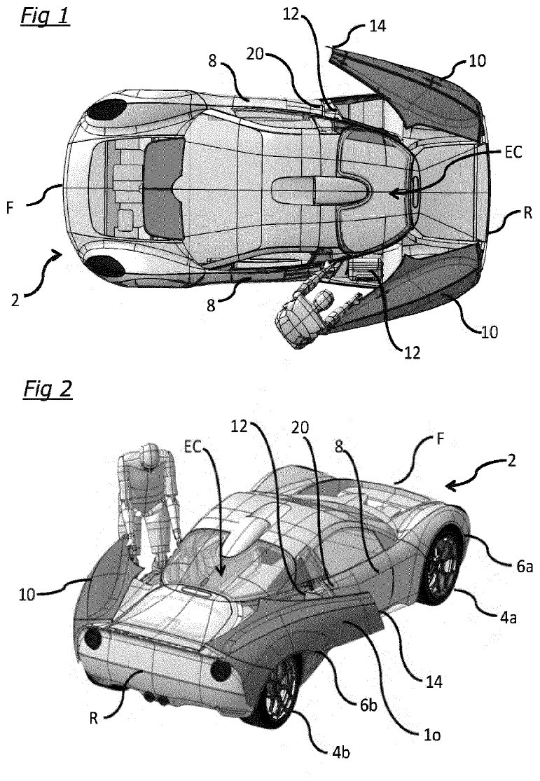

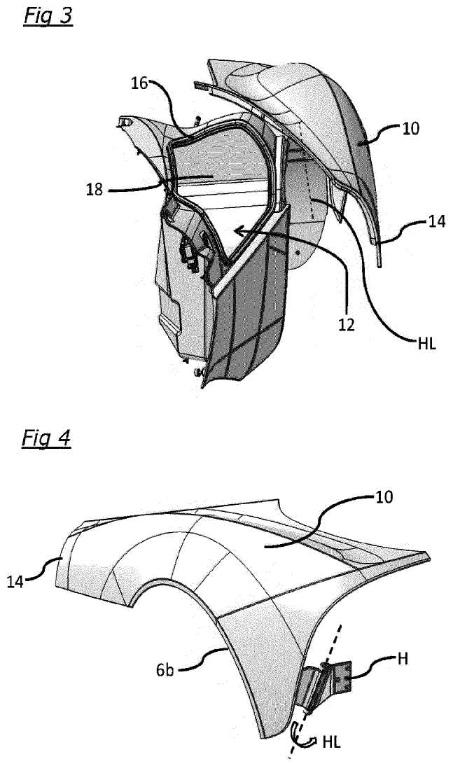

FIGS. 1 and 2 show a motor vehicle 2 having a front end F and a rear end R, front and rear wheels 4a, 4b, respectively which are located in front and rear wheel arches 6a, 6b, and passenger doors 8. An engine (not shown) sits inside the vehicle 2 in an engine compartment EC. To the rear of the vehicle, two upper bodywork panels 10 (edges of which define part of the rear wheel arch 6b (see FIG. 4)) are hinged so as to be pivotable between an open and a closed position (shown open in FIGS. 1 to 3). Behind the panels 10 when closed is a luggage compartment 12, one on each side of the vehicle 2 (in FIGS. 1 and 2 the left hand side luggage compartment 12 is occupied by a suitcase, while the right hand luggage compartment is empty). When closed, the panels 10 overlap the opening 18 (see FIG. 3) into the luggage compartment 12 around its entire circumference to allow a complete weatherproof seal to be formed to protect the contents of the luggage compartment 12.

As shown in FIGS. 3 and 4, the panels are arranged to open and close by pivoting on a hinge H which joins the panel 10 to the vehicle 2, and which has a hinge axis HL, this axis HL being oriented relative to the vehicle 2 so as to maximise movement of the leading edge 14 of each panel 10 in the horizontal, transverse direction, but with a minor component in the vertical direction and some movement around the longitudinal axis. The latter two movements allow the interior surface of the panel 10 to seat easily and without abrasive sliding against rubber seal 16 which is provided around the edge of the aperture 18 which is the opening into the luggage compartment 12. The hinge H is located behind the rear wheel arch and adjacent the rear of the vehicle so that it can be mounted to a rigid, structural part of the vehicle, just forwardly of the rear bumper/panel.

The aperture 18 is arranged so as to extend over the top of the compartment 12 (so that loading and unloading of luggage is mainly accomplished by a vertical movement), but the aperture also extends down the outer side of the vehicle by an equivalent amount so that luggage loading may be effected by moving the luggage into the aperture while tilted away from the vehicle, before being lowered vertically (unloading is the opposite); this assists easy loading and unloading, particularly if the luggage is heavy, whilst also ensuring that the stowed luggage is secure against transverse or longitudinal forces because it is retained by the walls of the storage compartment, which extend completely circumferentially around the compartment 12 for a significant proportion of its vertical height. The edge of the aperture 18 at the outer side of the compartment 12 does not extend as far as the floor of the luggage compartment.

The leading edge 14 of each panel 10 is shaped and configured so as to fit snugly transversely beneath the trailing edge 20 of the associated door 8, so that an additional rubber seal (not shown, but provided on the panel 10 and/or on the door 8) may provide an airtight and weather-resistant seal between the panel 10 and the door 8 When both are closed the door 8 overlaps the panel 10 so as positively to resist the opening of the panel 10 while the door 8 is closed, when driving for example (this arrangement prevents the panels 10 from opening unless the door is open).

In one of our designs, the transverse opening movement of the panels 10 is stopped (by a telescopic strut) at the position shown in FIG. 1 so as to give a maximum width W of 2.7 m or less, which is the width of a typical parking bay. This allows easy loading and unloading of the luggage compartment 12, and also allows further access into the engine compartment EC, as can be seen in FIGS. 1 and 2. Each luggage compartment is approximately 71 litres in volume, which is more than sufficient to contain a standard, airline hand luggage-sized case.

It will of course be understood that many variations may be made to the above-described embodiment without departing from the scope of the present invention. For example, the vehicle is shown with only two doors, with one on each side of the vehicle, but the invention is applicable to vehicles with more than two side doors, where a luggage compartment would be provided behind the rearmost doors. The panels may be made of metal alloy or of a composite material such as carbon fibre composite (CFC), and they may be simple shaped panels or they may have additional framework to strengthen them, and the walls defining the luggage compartment may be made of the same materials and/or they may be additionally strengthened to provide a structural support to the chassis of the vehicle 2. Additional rubber seals may be provided to ensure that the closed panels 10 fit securely against the body of the vehicle. The telescopic strut used to retain the panels in the open position may also be spring-loaded, hydraulic, or air-sprung so as to assist in opening the panels. Additionally or alternatively, there may be a conventional stay for holding the panel in the open position and ensuring it only opens to the desired extent. There may be additional means and/or safety latches for locking the panels in the closed position, even when the door on that side is open.

Where different variations or alternative arrangements are described above, it should be understood that embodiments of the invention may incorporate such variations and/or alternatives in any suitable combination.

1. A motor vehicle having an outer bodywork surface including a front and a rear wheel arches and at least one passenger or driver door on each side of the vehicle, in which a luggage compartment is provided on at least one side of the vehicle, the luggage compartment being located within the outer bodywork surface and forwardly of the rear wheel arch, the luggage compartment having an opening extending at least partially over the top of the luggage compartment and which is closable with a hinged panel, the panel comprising a bodywork panel forming part of the outer bodywork surface of the vehicle and having a hinge which is located behind the rear of the luggage compartment.

2. A motor vehicle according to claim 1, in which the hinge is located adjacent the rear of the motor vehicle.

3. A motor vehicle according to claim 1, in which the hinge has an axis about which the hinge pivots when the panel is opened or closed, and in which the axis is oriented so as to have both a vertical and a transverse component.

4. A motor vehicle according to claim 3, in which the vertical component is significantly greater than the transverse component.

5. A motor vehicle according to claim 4, in which the axis is oriented so as to have a longitudinal component, perpendicular to the vertical and transverse directions.

6. A motor vehicle according to claim 1, in which the panel has a leading edge at its forward end, the panel extending so that in the closed position at least part of the leading edge is positioned forwardly of the rearmost part of the rearmost door on that side of the vehicle.

7. A motor vehicle according to claim 6, in which the panel at its leading edge is shaped and configured so as to be complementary to the shape and configuration of the rearmost part of the rearmost door on that side of the vehicle.

8. A motor vehicle according to claim 1, further comprising a telescopic strut having one end fixed to the vehicle and its other end fixed to the panel, for assisting in opening the panel and/or for holding the panel in its open position.

9. A motor vehicle according to claim 1, in which the opening extends at least partially to the side of the luggage compartment towards the side of the motor vehicle.

10. A motor vehicle according to claim 1 comprising two luggage compartments and two closable panels, one luggage compartment and one panel on each side of the vehicle.
